(19) United States
(12) Patent Application Publication
(10) Pub. No.: US 2014/0175855 A1
(43) Pub. Date: Jun. 26, 2014

(54) MATTE POWDER COATING COMPOSITION

(71) Applicants: HYUNDAI MOTOR COMPANY, Seoul (KR); KIA MOTORS CORPORATION, Seoul (KR)

(72) Inventor: Hwan-Ho Kim, Bucheon (KR)

(73) Assignees: KIA MOTORS CORPORATION, Seoul (KR); HYUNDAI MOTOR COMPANY, Seoul (KR)

(21) Appl. No.: 13/858,328

(22) Filed: Apr. 8, 2013

(30) Foreign Application Priority Data
Dec. 24, 2012 (KR) 10-2012-0151808

(51) Int. Cl. C09D 5/03

(52) U.S. Cl. CPC C09D 5/032
USPC 301/5.1; 524/513; 524/40; 524/352

(57) ABSTRACT

Disclosed is a matte powder coating composition, and more specifically, a novel matte powder coating composition comprising a plurality of heterogeneous resins having different refractive indices, which can secure a coated film having excellent corrosion resistance and which embodies a matt effect on par with a liquid coating.

### CROSS-REFERENCE TO RELATED APPLICATION

The present application claims priority to Korean Patent Application No. 10-2012-0151808, filed on Dec. 24, 2012, the entire contents of which is incorporated herein for all purposes by this reference.

### BACKGROUND

(a) Technical Field

The present invention relates to a powder coating composition, and more specifically, to a novel matte powder coating composition which provides a coated film having excellent corrosion resistance and which can further provide a matte effect similar to that of a liquid coating.

(b) Background Art

The use of a matte clear finish on vehicles, particularly various external features of vehicles such as aluminum wheels, has recently increased due to customer demands and the improvement in merchantable quality that the matte clear finish provides the external appearance of vehicles.

A conventional matte clear finish used for vehicles is a liquid composition. Such a liquid composition is problematic in that the liquid can't be applied to a front side processed-type aluminum wheel, which has a maximum thickness of 30 μm, and includes a coated film thickness of 60 μm or more to provide adequate corrosion resistance. Currently, the “front side processed-type aluminum wheel” means a specification of exposing aluminum by conducting a mechanical process on the surface followed by coating only the clear coating.

Accordingly, a matte clear finish that can be provided using a power coating composition having excellent corrosion resistance is needed. Such a composition should be capable of providing the same matte effect provided by the liquid type composition, and should be capable of securing a coated film thickness of 60 μm or more.

A conventional matte clear powder composition for application to an aluminum wheel has been provided which satisfied the desired corrosion resistance properties. However, the composition provides the matte effect simply by applying heterogeneous resins so as to make the coated film hazy. Accordingly, it remains difficult to embody various matte textures demanded by customers.

The description provided above as a related art of the present invention is only for enhancement of understanding the background of the present invention and should not be construed as being included in the related art known by those skilled in the art.

### SUMMARY OF THE DISCLOSURE

The present invention has been made in an effort to solve the above-described problems associated with the prior art. According to aspects of the present invention, a matte powder coating composition for vehicle parts, such as an aluminum wheel, is provided. According to various embodiments, the matte powder coating composition is capable of providing various novel matte textures, particularly by application of heterogeneous resins having different refractive indices and a surface controlling resin.

According to various embodiments, the matte powder coating composition according to the present invention comprises a plurality of heterogeneous resins having different refractive indices.

According to various embodiments, the heterogeneous resins are selected from one or more acryl resin and polyester resin. Preferably, the heterogeneous resins include at least one acyl resin and at least one polyester resin, preferably wherein an amount of the acryl resin is about 20 to 30 wt % and an amount of the polyester resin is about 70 to 80 wt %, based on the total composition (i.e., homogenous resins) weight. According to various embodiments, the powder composition may mainly only comprise the homogoneous resin composition and, as such, the wt % may be about 20 to 30 wt % acryl resin and about 70 to 80 wt % polyester resin, relative to the total weight of the powder coating composition. However, further additional ingredients conventionally added to such coating compositions may also be included and, as such, the wt % of the acryl resin and the polyester resin may be based on the total weight of the homogenous resin composition.

According to various embodiments, the powder coating composition further comprises a surface tension controlling resin in a suitable amount, such as about 0.1 to 0.5 wt %, relative to the total weight of the powder coating composition. Any conventional surface tension controlling resin can suitably be used. According to an exemplary embodiment, the surface tension controlling resin is cellulose acetate butyrate (CAB).

According to various embodiments, the powder coating composition further comprises a curing agent, a leveling agent, an ultraviolet absorbing agent, and/or an anti-pinhole agent. One or more of these various agents can be added in a suitable amount, such as a curing agent at about 0.5 to 2 wt %, a leveling agent at about 0.5 to 2 wt %, an ultraviolet absorbing agent at about 0.1 to 1 wt % and an anti-pinhole agent at about 0.1 to 1 wt %, based on the total weight of the powder coating composition. Any conventional agents can suitably be used. According to an exemplary embodiment, the curing agent is blocked isocyanate, the leveling agent is a modified silicone acryl resin, the ultraviolet absorbing agent is a benzophenol derivative and the anti-pinhole agent is an acryl copolymer.

According to another aspect, the present invention provides an aluminum wheel coated with the matte powder coating composition of the present invention.

Other aspects and exemplary embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a schematic diagram showing a coated film structure by applying a conventional matte powder coating composition;

FIG. 2 is a schematic diagram showing a coated film structure by applying the matte powder coating composition according to an embodiment of the present invention; and

FIG. 3 is a schematic diagram showing a principle of embodying a matt texture by application of the powder coating composition according to an embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

The terms and the words used in the specification and claims should not be construed with common or dictionary meanings, but construed as meanings and conception coinciding the spirit of the invention based on a principle that the inventors can appropriately define the concept of the terms to explain the invention in the optimum method. Therefore, embodiments described in the specification and the configurations shown in the drawings are not more than the most preferred embodiments of the present invention and do not fully cover the spirit of the present invention. Accordingly, it should be understood that there may be various equivalents and modifications that can replace those when this application is filed.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Herein, a powder coating composition means a powder type coating: which does not comprise a solvent typically used for general coatings (e.g. an organic solvent, reactive monomers and water), and is composed of size-regulated particles prepared by optionally mixing proper dyes, curing agents and the like, homogeneously melting and mixing thereof to obtain dispersion, and cooling the dispersion followed by pulverizing thereof to a particle size of a desired range.

A powder coat using such a powder coating according to the present invention provides excellent physical properties of the coated film, does not require significant worker's proficiency as compared to a solvent-type coating, and provides excellent impact resistance. The present powder coat can be applied by a variety of methods such as by electrostatic spray coating method, fluidized bed method, electrostatic fluidized bed method and the like.

Hereinafter, present invention now will be described in detail with reference to the accompanying drawings.

In one aspect, the present invention relates to a matte powder coating composition embodying various matte textures.

In contrast with structural and industrial products, coatings for vehicle parts, such as wheels, must meet merchantable quality standards. Accordingly, studies have been ongoing for providing various textures and colors to such coatings by controlling, for example, viscosity, amount and the like of additives.

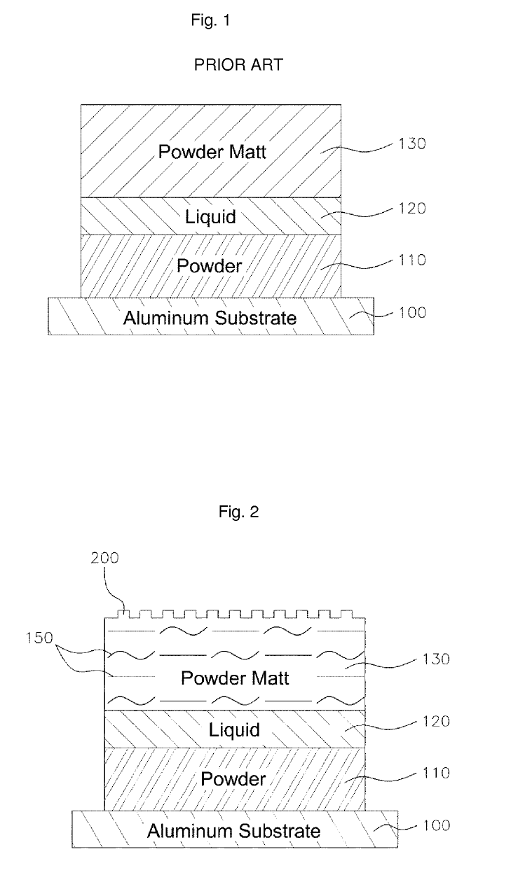

FIG. 1 is a schematic diagram showing a coated film structure by applying a conventional matte powder coating composition. In particular, the surface becomes hazy by providing layers of a powder primer 110, a liquid base 120, a powder matte clear coated layer 130 and the like in sequence on the surface of an aluminum substrate 100. Further, by applying heterogeneous polymers on the powder matte clear coated layer 130, a matte effect is provided.

On the other hand, FIG. 2 is a schematic diagram showing a coated film structure provided by applying the matte powder coating composition according to an embodiment of the present invention. As shown in FIG. 2, the coated film structure includes a powder primer 110, a liquid base 120, a powder matte clear coated layer 130. Further, various novel matte effects are embodied by heterogeneous resins 150 having different refractive indices and/or a finely rugged surface structure 200 provided by a surface tension controlling resin and the like on the powder matt clear coated layer 130.

According to a preferred embodiment, the powder coating composition according to the present invention comprises heterogeneous resins having different refractive indices. In particular, according to various embodiments, the heterogeneous resins include at least one acryl resin and at least one polyester resin. According to an exemplary embodiment, the heterogeneous resins include at least one acryl resin (for powder coating) having the refractive index of about 1.56 and playing a role of improving major physical properties such as gloss, acid resistance and weatherablity of a subject to be coated, and at least one polyester resin having a refractive index of about 1.52 and playing a role of improving major physical properties such as gloss controlling and external appearance.

According to a preferred embodiment, the powder coating composition comprises about 20 to 30 wt % acryl resin and about 70 to 80 wt % polyester resin (for powder coating), based on total composition (total heterogeneous resins) weight. When the amount of the acryl resin is less than about 20 wt % and the amount of the polyester resin is in excesses of about 80 wt %, major physical properties may be deteriorated, and the matte effect may not be adequately expressed. Further, and when the amount of the acryl resin is in excesses of about 30 wt % and the amount of the polyester resin is less than about 70 wt %, the matte effect may not be adequately expressed. Accordingly, it is preferred to satisfy the said range.

According to various embodiments, it is preferred that the powder coating composition further comprises a surface tension controlling resin in a suitable amount, such as about of 0.1 to 0.5 wt %, based on total composition (total heterogeneous resins) weight. When the amount thereof is less than about 0.1 wt %, a desired fine surface structure may not be adequately embodied, and when it is in excesses of about 0.5 wt %, the quality of external appearance may be largely deteriorated. Accordingly, it is preferred to satisfy the above range.

According to various embodiments, the surface tension controlling resin plays a role of providing the coating with a finely rugged surface structure for embodying a desired matte effect. The surface tension controlling resin can be any conventional such resins, and according to preferred embodiments, it is a cellulose acetate butyrate (CAB) and the like.

According to various embodiments, the powder coating composition further comprises one or more of a curing agent, a leveling agent, an ultraviolet absorbing agent, an anti-pinhole agent, and other agents that are commonly added to coating compositions. According to an exemplary embodiment, the powder coating composition comprises about 0.5 to 2 wt % curing agent, about 0.5 to 2 wt % leveling agent, about 0.1 to 1 wt % ultraviolet absorbing agent, about 0.1 to 1 wt % anti-pinhole agent, and the like, based on total weight of the powder coating composition.

The curing agent plays a role of controlling curing of the coating and reaction speed, and any such conventional agents may be used. According to a preferred embodiment, the curing agent is a blocked isocyanate and the like.

It is preferred that the curing agent is added to the powder coating composition in an amount of about 0.5 to 2 wt %, based on total weight of the powder coating composition. When the amount is less than about 0.5 wt %, the potential of uncuring may increase, and when exceeds about 2 wt %, storage stability may be deteriorated. Accordingly, it is preferred to satisfy the above range.

Further, the leveling agent plays a role of improving coating leveling (i.e. providing a smooth, level coating), and any such conventional agents may be used. According to a preferred embodiment, the leveling agent is a modified silicone acryl resin and the like.

It is preferred that the leveling agent is added to the powder coating composition in an amount of about 0.5 to 2 wt %. When the amount is less than about 0.5 wt %, the coating leveling may be deteriorated, and when it exceeds about 2 wt %, the potential for the occurrence of sagging may increase. Accordingly, it is preferred to satisfy the above range.

Further, the ultraviolet absorbing agent plays a role of preventing surface aging by ultraviolet (UV), and any agents typically used as such can be used in the present invention. According to an exemplary embodiment, the ultraviolet absorbing agent is a benzophenol derivative and the like.

It is preferred to add the ultraviolet absorbing agent in an amount of about 0.1 to 1 wt %. When the amount is less than about 0.1 wt %, surface damages can be generated, and when it exceeds about 1 wt %, the quality of the external appearance may be deteriorated. Accordingly, it is preferred to satisfy the above range.

Further, the anti-pinhole agent plays a role of preventing surface pinhole, and any agents typically used as such can be used in the present invention. According to an exemplary embodiment, the anti-pinhole agent may be an acryl copolymer and the like.

It is preferred to add the anti-pinhole agent in an amount of about 0.1 to 1 wt %. When the amount is less than about 0.1 wt %, the ability of preventing the occurrence of pinhole after curing of the coating may be deteriorated, and when it exceeds about 1 wt %, the quality of the external appearance may be deteriorated. Accordingly, it is preferred to satisfy the above range.

The powder coating composition having the above composition can be coated by any common coating method.

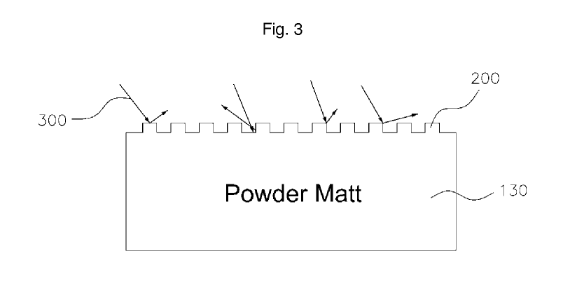

FIG. 3 is a schematic diagram showing a principle of embodying matte texture by the powder coating composition according to the present invention. As shown therein, the matte texture may be embodied by scattered reflection of light 300 irradiated to the surface of the coated film by applying the finely rugged structure 200. According to various embodiments, such a finely rugged structure 200 can be formed on the surface of the coating film by the surface tension controlling resin, and through use of heterogeneous resins having different refractive indices.

### Example 1

Hereinafter, the present invention will be described in further detail with reference to examples. It will be obvious to a person having ordinary skill in the art that these examples are illustrative purposes only and are not to be construed to limit the scope of the present invention.

TABLE 1

| | Test Result | | | |
|---|---|---|---|---|
| Test Item/Test Standard | Conventional Product | | Example 1 | |
| Coated Film Thickness/When | 100 | μm | 100 | μm |
| using front side processed-type | | | | |
| aluminum wheel, 60 μm or more | | | | |
| Gloss/60 degree method, | 20 | | 11 | |
| Gloss for securing merchantable | | | | |
| quality: 9~13 | | | | |
| Salt Spray Resistance/One side, | 1 | mm | 1 | mm |
| 720 hours later after SST (Salt | | | | |
| Spray Test): 3 mm or less | | | | |

| | | |
|---|---|---|
| Hardness/HB or more | H | HB |
| Adhesive Property/After water | M-1.0 | M-1.0 |
| resistance test (40° C.) and | (Excellent) | (Excellent) |
| moisture resistance test (° C.): | | |
| M-2.5 or more | | |
| Chipping Resistance/ | Good | Good |
| Cold resistance: −30° C. | | |
| Chemical Resistance/Acid | Good | Good |
| resistance test and Alkali resistance | | |
| test | | |
| Solvent Resistance/Tested | Good | Good |
| 10 times or more with xylene | | |
| Accelerated Weatherablity/WOM | M-1.0 | M-1.0 |
| (Weather-o-meter) 300 hours later, | (Excellent) | (Excellent) |
| Adhesive property: M-2.5 or more | | |

The powder coating composition having the composition according to the present invention was coated on an aluminum wheel, and tests for each of the required physical properties are listed in Table 1.

The above test standards represent preferable standards of physical properties for application to the aluminum wheel. As demonstrated, the powder coating composition according to the present invention satisfied all of the test standards of test items, coated film thickness, gloss, salt spray resistance, hardness, adhesive property, chipping resistance, chemical resistance, solvent resistance and accelerated weatherablity. Further, it was confirmed that the coating according to the present invention demonstrated physical properties of an equivalent level compared with the conventional powder coating composition, and also embodied a matte texture of the best merchantable quality.

The above powder coating composition embodies various novel matte textures which can be provided by surface scattered reflection. Accordingly, the present coating can be extensively applied to all parts (e.g. all parts of a vehicle and other surfaces that may suitably be coated with a matte coating) in addition to the aluminum wheel.

The powder coating composition according to the present invention having the constitution described above is suitably applied to vehicle parts, such as an aluminum wheel and the like, and thereby has an effect of embodying various novel matte textures unlike conventional matte powder coatings.

Namely, the present coating can be applied to vehicle parts, such as an aluminum wheel, to meet increased customer demands on various matte effects. Accordingly, it can significantly improve the merchantable quality and can be extensively applied to all parts of a vehicle using powder coating techniques.

The invention has been described in detail with reference to preferred embodiments thereof. However, it will be appreciated by those skilled in the art that changes or modifications may be made in these embodiments without departing from the principles and spirit of the invention, the scope of which is defined in the appended claims and their equivalents.

What is claimed is:

1. A powder coating composition for forming a matte powder coating comprising: a plurality of heterogeneous resins having different refractive indices.

2. The powder coating composition according to claim 1, wherein the heterogeneous resins are selected from the group consisting of acryl resins and polyester resins.

3. The powder coating composition according to claim 2, wherein the heterogeneous resins comprise about 20 to 30 wt % acyl resin and about 70 to 80 wt % polyester resin, based on a total heterogeneous resins weight.

4. The powder coating composition according to claim 3, which further comprises about 0.1 to 0.5 wt % of a surface tension controlling resin, based on a total weight of the powder coating composition.

5. The powder coating composition according to claim 4, wherein the surface tension controlling resin is cellulose acetate butyrate (CAB).

6. The powder coating composition according to claim 4, which further comprises about 0.5 to 2 wt % of a curing agent, about 0.5 to 2 wt % of a leveling agent, about 0.1 to 1 wt % of an ultraviolet absorbing agent, and about 0.1 to 1 wt % of an anti-pinhole agent.

7. The powder coating composition according to claim 6, wherein the curing agent is a blocked isocyanate, the leveling agent is a modified silicone acryl resin, the ultraviolet absorbing agent is a benzophenol derivative and the anti-pinhole agent is an acryl copolymer.

8. An aluminum wheel coated with the powder coating composition according to claim 1.
